(19) United States
(12) Patent Application Publication
(10) Pub. No.: US 2010/0287923 A1
(43) Pub. Date: Nov. 18, 2010

(54) PRESSURE RESERVOIR, IN PARTICULAR FOR A HYDRAULIC UNIT OF A HYDRAULIC VEHICLE BRAKE SYSTEM WITH ELECTRONIC SLIP CONTROL

(76) Inventors: Alexander Bareiss, Immenstadt (DE); Dieter Merklein, Hergatz (DE); Andreas Weh, Sulzberg (DE); Holger Fischer, Haldenwang (DE); Taro Segawa, Sonthofen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/735,179

(22) PCT Filed: Oct. 23, 2008
(86) PCT No.: PCT/EP2008/064399

§ 371 Date: Jul. 20, 2010

(30) Foreign Application Priority Data
Dec. 18, 2007 (DE) 10 2007 060 951.7

(51) Int. Cl. F16D 31/02

(52) U.S. Cl. 60/413

(57) ABSTRACT

The invention relates to a pressure accumulator, especially for a hydraulic unit of a hydraulic vehicle braking system with electronic wheel slip regulation. Pressure accumulators having an accumulator piston acted on by a piston spring are known according to prior art. In order to save costs on parts for the piston spring and to save space in terms of the pressure accumulator, a piston spring having at least one first spring winding is used. According to the invention, the outer diameter of the first winding is smaller than the inner diameter of a second spring winding connected thereto.

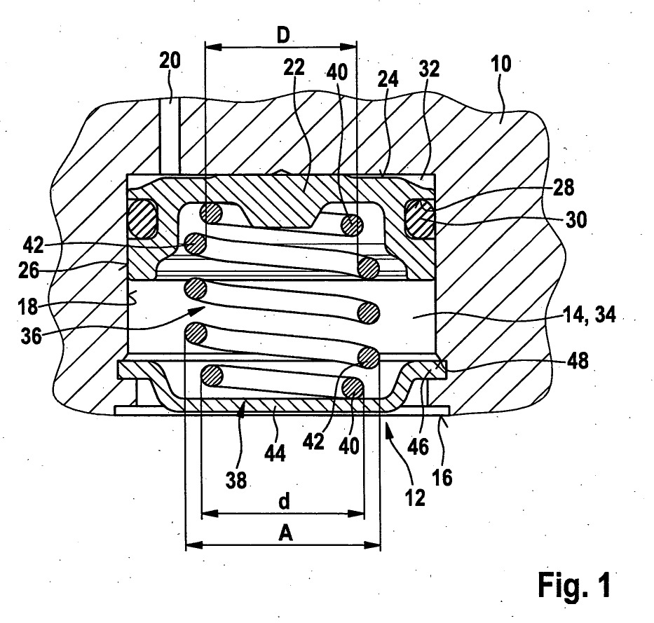

### PRIOR ART

The invention relates to a pressure reservoir, in particular for a hydraulic unit of a hydraulic vehicle brake system with electronic slip control, as defined by the generic characteristics of the preamble to claim 1. One such pressure reservoir is known for instance from the disclosure in German Patent Document DE 199 42 293 A1. This pressure reservoir includes a storage chamber, a storage piston guided movably in the storage chamber, a piston spring acting on the storage piston, and a cap which closes off the storage chamber from the environment and on which the piston spring is braced.

As the piston spring, a spiral spring with a plurality of spring windings is used. All the spring windings uniformly have the same outside diameter. The spring windings on the ends of the piston spring are polished and are placed against the spring windings directly adjoining them.

Piston springs with polished ends are relatively expensive to produce. Moreover, the block length in particular of a piston spring determines the dimensions of a storage chamber. Since this storage chamber is produced by metal-cutting machining of the housing block, there is either relatively major machining expense in the form of tool use and machined material, or the pressure reservoir protrudes in some portions past the outline of the housing block and as a result is unprotected against mechanical damage. Large storage chambers mean correspondingly sized housing blocks and hydraulic units. However, especially in automotive construction, the robustness and compactness of the structural units are especially significant, for lack of available installation chamber.

### ADVANTAGES OF THE INVENTION

By comparison, a pressure reservoir as defined by the definitive characteristics of the body of claim 1 has the advantage of lesser costs for parts, by the use of more-economical piston springs that are not resurfaced by grinding. The piston springs proposed according to the invention moreover have a lesser block mass, so that for pressure reservoirs with more-compact dimensions but unaltered functional properties can be made. More-compact dimensions save machining effort and economize on the use of material for the housing block, make hydraulic units with a lesser structural volume possible, and furthermore allow a pressure reservoir to be integrated with the housing block, so that the pressure reservoir is protected against mechanical damage from outside.

Further advantages or advantageous refinements of the invention will become apparent from the dependent claims and the ensuing description.

### DRAWINGS

One exemplary embodiment of the invention is shown in the drawing and described in detail in the ensuing description. The sole FIGURE of the drawing shows a pressure reservoir of the invention in longitudinal section.

### DESCRIPTION OF THE EXEMPLARY EMBODIMENT

The sole FIGURE of the drawing shows a fragment of a housing block 10, with a pressure reservoir 12 of the invention. A storage chamber 14 of this pressure reservoir 12 begins at an outside 16 of the housing block 10 and extends into the interior of the housing block 10. The storage chamber 14 is formed by a blind-borelike recess 18, which has been made by metal-cutting machining of the housing block 10. Via a conduit bore 20 at the base of this recess 18, the pressure reservoir 10 is put into contact with a hydraulic circuit of the vehicle brake system.

A storage piston 22 is guided axially displaceably in the interior of the storage chamber 14. This storage piston 22 is embodied as a hollow piston and has a closed piston bottom 24 and an encompassing annular wall 26 connected in one piece to the piston bottom. A sealing groove 28 open toward the outside is embodied on the circumference of this annular wall 26, and a sealing ring 30 is inserted into it. The storage piston 22 thus seals off a pressure chamber 32, which can be acted upon by pressure medium, from a pressure medium-free installation chamber 34. The piston interior is stepped a single time in diameter so that the annular piston wall 26, on its end toward the piston bottom 24, has a larger cross section than on its end toward the installation chamber and remote from the piston bottom.

A piston spring 36 is accommodated in the installation chamber 34. The piston spring protrudes in some portions into the interior of the storage piston 22 and is braced by one end on the inside of the piston bottom 24. With its opposite second end, the piston spring 36 rests on a cap 38, which is anchored firmly to the housing block 10 and closes off the storage chamber 14 from the outside.

The piston spring has, as an example, five spring windings; the two first spring windings 40 on the ends have a uniform large outside diameter d, which is smaller than the inside diameter D of the second spring windings 42 that immediately adjoin these first spring windings. The first spring windings 40 are placed against the second spring windings 42 in such a way that their spring ends cannot catch on the second spring windings 42. In the exemplary embodiment shown, these second spring windings 42 likewise have a uniformly large outside diameter A. It would also be conceivable to provide at least one third spring winding (not shown) between the second spring windings 42, the outside diameter of which second spring winding is increased still further compared to the outside diameter of the second spring windings 42.

The first spring windings 40 that form the ends of the piston spring 36 do not have polished wire ends. Thus the piston spring 36 has a uniform wire cross section continuously from its one end to the outer end.

The axial length of the annular piston wall 26 and its stepped inner contour are embodied such that when the piston spring 36 is under maximum load, at least one of the spring windings with the largest outside diameter assumes a position in the interior of the storage piston 22. When maximally acted upon by the pressure of the pressure reservoir 12, the piston spring 36 is compressed to a block. The first spring windings 40, because of their reduced outside diameter, are then located inside the second spring windings 42 and thus make no contribution to increasing the block length of the piston spring 36. Compared to pressure reservoirs that are equipped with conventional piston springs, pressure reservoirs 12 with piston springs 36 designed according to the invention, with the same volume of their pressure chambers 32, have a reduced structural length. Accordingly, they can be integrated entirely with the housing block 10 of a hydraulic unit.

The cap 38 used is embodied in bowl-like form and has an encompassing rim 46 that protrudes axially relative to a cap bottom 44. This rim 46 rests on a shoulder 48 of the housing block 10, which shoulder surrounds the storage chamber 34. The shoulder is formed by a flat countersunk feature, which ends so deeply in the interior of the housing block 10 that, in the crimped state of the cap bottom 44, it does not protrude past the outside 16 of the housing block 10. Preferably, the cap 38 should end flush with the outside 16. In comparison to conventional pressure reservoirs with springs that have polished ends and spring windings with uniform outside diameters, pressure reservoirs according to the invention can be equipped with caps 38 that are comparatively flat and can therefore also be produced more economically.

Anchoring the cap 38 of the pressure reservoir 12 to the housing block 10 is done by non-cutting forming techniques, such as crimping, axial calking, tumbling, or rumbling. In the process, material of the housing block is plastically deformed in such a way that in at least some portions it covers the cap 38 in the radial direction. For many applications, it is sufficient to dispense with a closed deformation of material surrounding the pressure reservoir 12 and instead to crimp or calk only a plurality of segments distributed along the circumference of this cap 38.

It is understood that modifications or additions to the exemplary embodiment described may be made without departing from the fundamental concept of the invention.

1-9. (canceled)

10. A pressure reservoir, in particular for a hydraulic unit of a hydraulic vehicle brake system with electronic slip control, comprising:
a storage chamber;
a storage piston, which is disposed displaceably in the storage chamber and seals off a pressure chamber, which pressure chamber is fellable with hydraulic pressure medium, from a pressure medium-free installation chamber;
a piston spring, acting on the storage piston and disposed in the installation chamber, which is embodied in the form of a spiral spring and has a plurality of spring windings; and
a cap, closing off the installation chamber from the environment, on which cap the piston spring is braced by one end of the cap, the piston spring having at least one first spring winding, whose outside diameter is smaller than an inside diameter of a second spring winding directly adjoining the first spring winding.

11. The pressure reservoir as defined by claim 10, wherein the at least one first spring winding is disposed on one end of the piston spring.

12. The pressure reservoir as defined by claim 10, wherein the piston spring has first spring windings, of reduced outside diameter, on both ends, and the first spring windings have a uniform outside diameter, and the second spring windings directly adjoining these first spring windings have a uniform outside diameter that is larger than the outside diameter of the first spring windings.

13. The pressure reservoir as defined by claim 11, wherein the piston spring has first spring windings, of reduced outside diameter, on both ends, and the first spring windings have a uniform outside diameter, and the second spring windings directly adjoining these first spring windings have a uniform outside diameter that is larger than the outside diameter of the first spring windings.

14. The pressure reservoir as defined by claim 10, wherein between the second spring windings, at least one third spring winding of by comparison larger outside diameter is provided.

15. The pressure reservoir as defined by claim 11, wherein between the second spring windings, at least one third spring winding of by comparison larger outside diameter is provided.

16. The pressure reservoir as defined by claim 12, wherein between the second spring windings, at least one third spring winding of by comparison larger outside diameter is provided.

17. The pressure reservoir as defined by claim 13, wherein between the second spring windings, at least one third spring winding of by comparison larger outside diameter is provided.

18. The pressure reservoir as defined by claim 10, wherein the piston spring has a uniform wire cross section continuously from one end to an other end.

19. The pressure reservoir as defined by claim 11, wherein the piston spring has a uniform wire cross section continuously from one end to an other end.

20. The pressure reservoir as defined by claim 12, wherein the piston spring has a uniform wire cross section continuously from one end to an other end.

21. The pressure reservoir as defined by claim 14, wherein the piston spring has a uniform wire cross section continuously from one end to an other end.

22. The pressure reservoir as defined by claim 17, wherein the piston spring has a uniform wire cross section continuously from one end to an other end.

23. The pressure reservoir as defined by claim 10, wherein the storage chamber is embodied as a blind-borelike recess on a housing block of a hydraulic unit, and the cap closing the storage chamber is disposed in indented fashion compared to an outside of the housing block, or ends flush with the outside of the housing block.

24. The pressure reservoir as defined by claim 22, wherein the storage chamber is embodied as a blind-borelike recess on a housing block of a hydraulic unit, and the cap closing the storage chamber is disposed in indented fashion compared to an outside of the housing block, or ends flush with the outside of the housing block.

25. The pressure reservoir as defined by claim 10, wherein the cap is embodied is in bowl-like form and has a cap bottom and an encompassing rim protruding axially from the cap bottom, and the cap is anchored to the housing block by plastic deformation of a material of the housing block.

26. The pressure reservoir as defined by claim 24, wherein the cap is embodied is in bowl-like form and has a cap bottom and an encompassing rim protruding axially from the cap bottom, and the cap is anchored to the housing block by plastic deformation of a material of the housing block.

27. The pressure reservoir as defined by claim 10, wherein the storage piston is embodied as a hollow piston, with a piston bottom and an encompassing annular wall integral with the piston bottom, and the piston spring plunges at least in some portions into a hollow interior of the storage piston.

28. The pressure reservoir as defined by claim 26, wherein the storage piston is embodied as a hollow piston, with a piston bottom and an encompassing annular wall integral with the piston bottom, and the piston spring plunges at least in some portions into a hollow interior of the storage piston.

29. The pressure reservoir as defined by claim 27, wherein a cross section of the annular wall of the storage piston tapers, beginning at the piston bottom, and that the piston spring, at least upon maximum load, plunges with at least one spring winding with a largest outside diameter, into the interior of the storage piston.
